(19) United States
(12) Patent Application Publication
(10) Pub. No.: US 2024/0070838 A1
(43) Pub. Date: Feb. 29, 2024

(54) ADDITIVE MANUFACTURING DEFECT DETECTION

(71) Applicant: NUtech Ventures, Lincoln, NE (US)

(72) Inventors: Ziyad Smoqi, Lincoln, NE (US); Prahalada Rao, Lincoln, NE (US); Benjamin Bevans, Lincoln, NE (US); Aniruddha Gaikwad, Lincoln, NE (US)

(21) Appl. No.: 18/240,879

(22) Filed: Aug. 31, 2023

Related U.S. Application Data
(60) Provisional application No. 63/402,684, filed on Aug. 31, 2022.

(51) Int. Cl. G06T 7/00; B22F 12/90; B33Y 50/02

(52) U.S. Cl. CPC G06T 7/0004; B22F 12/90; B33Y 50/02; G06T 2207/20081

(57) ABSTRACT

Methods, systems, and apparatus, including computer programs encoded on computer-storage media, for detection of defects in additive manufacturing. In some implementations, a method includes obtaining an image representing a volume of molten material; extracting one or more features from the image; providing the one or more features to a trained machine learning model; obtaining output from the trained machine learning model; and determining, using the output, a defect in a part.

### CROSS-REFERENCE TO RELATED APPLICATIONS

This application claims the benefit of priority to U.S. Provisional Application No. 63/402,684, filed on Aug. 31, 2022, the contents of which are hereby incorporated by reference.

### STATEMENT REGARDING FEDERALLY SPONSORED RESEARCH OR DEVELOPMENT

This invention was made with government support under ECCS2025298, CMMI1920245, CMMI1752069, IIP2044710, ECCS2020246, CMMI1739696, 01A1929172, and CMMI1719388 awarded by the National Science Foundation (NSF) and DE-SC0021136 awarded by the Department of Energy (DOE). The government has certain rights in the invention.

### FIELD

This specification generally relates to detecting defects in additively manufactured parts.

### BACKGROUND

Additive manufacturing involves construction of three-dimensional objects from a given model. Manufacturing processes include processes in which material is deposited, joined or solidified (such as plastics, liquids or powder grains being fused), typically layer by layer.

### SUMMARY

In some implementations, an additive manufacturing process (e.g., laser powder bed fusion (LPBF)) is monitored to detect one or more defects in a manufactured part. The process can be monitored using an imaging device, such as a pyrometer (e.g., a dual-wavelength imaging pyrometer). The imaging device can captured data from the additive manufacturing process. The data can include representations of meltpools where a material has been melted to manufacture a part. A computer can obtain the data and extract features for a trained machine learning model. By extracting features instead of processing raw data, the trained machine learning model can be relatively processor nonintensive (e.g., K-Nearest Neighbors compared to convolutional neural network (CNN)).

In some implementations, a defect detection process uses physics-informed meltpool signatures. For example, a defect detection process can include extracting physics-informed meltpool signatures from an in-situ dual-wavelength imaging pyrometer, and subsequently, analyzing these signatures using computationally tractable machine learning approaches.

Porosity in LPBF occurs despite extensive optimization of processing conditions due to stochastic causes. Hence, it is essential to continually monitor the process with in-situ sensors for detecting and mitigating incipient pore formation. In one example, a tall cuboid-shaped part (e.g., 10 mm×10 mm×137 mm, material ATI 718Plus) can be built with controlled porosity by varying laser power and scanning speed. Various types of porosity can occur during manufacturing of a given part. Porosity types can include lack-of-fusion and keyhole formation with varying degrees of severity.

In some implementations, a meltpool is continuously monitored using a dual-wavelength imaging pyrometer. The pyrometer can be installed in a machine for manufacturing one or more parts. Physically intuitive process signatures, such as meltpool length, temperature distribution, and ejecta (spatter) characteristics, can be extracted from one or more images of meltpools. Subsequently, relatively simple machine learning models, e.g., K-Nearest Neighbors, can be trained to predict both a severity and type of porosity as a function of physics-informed meltpool signatures. Accuracy can be similar to more computationally demanding, process intensive, black-box deep learning CNN which directly uses meltpool images instead of physics-informed features (e.g., in the range of 89% to 97%).

One innovative aspect of the subject matter described in this specification is embodied in a method that includes obtaining an image representing a volume of molten material; extracting one or more features from the image; providing the one or more features to a trained machine learning model; obtaining output from the trained machine learning model; and determining, using the output, a defect in a part.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, determining the defect includes determining a severity of porosity. In some implementations, determining the defect includes determining a type of defect. In some implementations, the type of defect is lack of fusion, conduction, or keyholing. In some implementations, actions include providing feedback to an additive manufacturing process, wherein the feedback is configured to adjust a manufacturing of the part. In some implementations, adjusting the manufacturing of the part includes adjusting one or more of a laser power, scanning speed, or delay.

In some implementations, determining the defect in the part includes determining that continuing an additive manufacturing process will cause the defect in the part without adjustments to the additive manufacturing process.

In some implementations, the one or more features include one or more of a value indicating a length of the volume, a value indicating a spread of ejecta, a value indicating a temperature of ejecta, or a value indicating a temperature of the volume.

In some implementations, the one or more features include one or more values indicating a shape of the volume of molten material.

In some implementations, the trained machine learning model includes one or more of a Logistic Regression (LR) model, a Support Vector Machine (SVM), or K-Nearest Neighbors (KNN) algorithm. In some implementations, actions include providing an indication that a second part has no defect.

In some implementations, a relatively small (e.g., 4) features are extracted from imaging data. Features can include meltpool shape and temperature from an imaging pyrometer. A machine learning model that is not process intensive can use extracted features to predict porosity. This physics-aided approach to a flaw monitoring and detection in additive manufacturing, such as LPBF, can have one or more of the following advantages.

Low-level meltpool temperature and shape features can be physically intuitive and relatively tractable to extract. Their interpretability and ease of computation aids rapid training of models with smaller data sets and can facilitate transferability across different materials and machines.

Computationally tractable machine learning approaches can be used to predict flaw formation instead of complex deep learning algorithms. Consequently, large volumes of meltpool data can be analyzed on an edge device, e.g., on-board a LPBF machine, without the need to transfer data away from the machine to a separate analysis engine. Such near-the-edge computation facilitates rapid process feedback correction. Such approaches can also reduce energy consumption and reduce processing times.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for additive manufacturing defect detection.

FIG. 2 is an illustration of meltpool image data and associated features.

FIG. 3 is a flow diagram illustrating an example of a process of obtaining input data and processing the input data to detect a defect.

FIG. 4 is a flow diagram illustrating an example of a process for additive manufacturing defect detection.

FIG. 5 is an example representation of a laser powder bed fusion (LPBF) additive manufacturing process.

FIG. 6 is an example photograph of a manufactured ATI 718Plus part.

FIG. 7 shows example meltpool images from multiple processing conditions.

FIG. 8 shows example scanning electron microscope (SEM) images of cross sections from multiple processing conditions.

FIG. 9 shows example optical microscopy images of processed parts.

FIG. 10 shows example X-ray computed tomography (XCT) analysis of a processed part.

FIG. 11 shows example XCT analysis of various sections.

FIG. 12 shows example porosity classification based on relative density.

FIG. 13 shows example correlations of porosity levels with meltpool images acquired from the dual wavelength imaging pyrometer.

FIG. 14 shows example shape and temperature-based statistical features extracted from pyrometry images.

FIG. 15 shows example correlations between features extracted from the dual-wavelength imaging pyrometer frames.

FIG. 16 shows an example comparison of different techniques for classifying type and severity of defects.

FIG. 17 shows an example confusion matrix for 4-way classification of porosity severity using a K-nearest neighbor (KNN) model.

FIG. 18 is a diagram illustrating an example of a computing system used for additive manufacturing defect detection.

Like reference numbers and designations in the various drawings indicate like elements.

### DETAILED DESCRIPTION

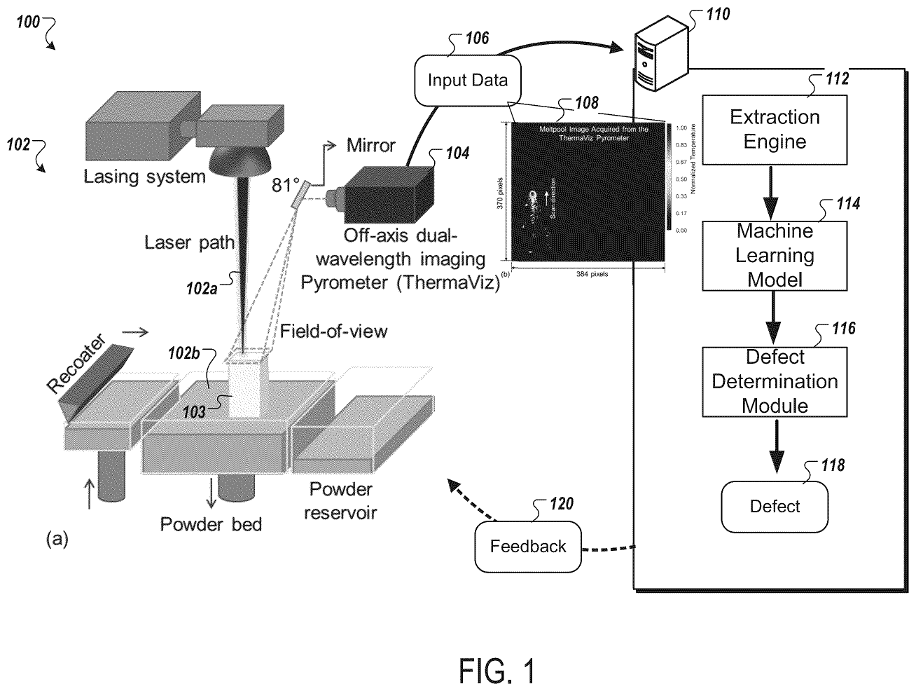

FIG. 1 is a diagram showing an example of a system for additive manufacturing defect detection. In some implementations, the system 100 includes a printing system 102. In some implementations, the system 100 includes an imaging device 104. In some implementations, the system 100 includes a control unit 110. The control unit 110 processes input data 106 generated by the imaging device 104. In some implementations, the control unit 110 provides feedback 120 to the printing system 102 indicating an adjustment to a printing process.

In some implementations, the printing system 102 includes a specific printer, such as an EOS M280 LPBF system. The EOS M280 LPBF system can utilize a continuous mode ytterbium-fiber laser (wavelength 1070 nm), such as a laser that has a Gaussian distribution with a spot size of 100 μm (e.g., 1/ε²).

In some implementations, the imaging device 104 is a dual wavelength imaging pyrometer. For example, the system 100 can be integrated with the imaging device 104 as a dual wavelength imaging pyrometer (e.g., Stratonics, ThermaViz) to acquire meltpool images. In some implementations, the imaging device 104 is in an off-axis configuration or inclined. For example, the imaging device 104 can be in an off-axis configuration and inclined at 81 degrees to the horizontal as illustrated in FIG. 1.

In some implementations, the imaging device 104 obtains meltpool images as the input data 106. The imaging device 104 can acquire images at a given sampling rate (e.g., 800 Hz) and a given resolution (e.g., 370×384 pixels or 29 μm per pixel spatial resolution). A sensor of the imaging device 104 can image a center of a processed part 103 (e.g., approximately 120 mm² in the center of the part 103). Image 108 is an example representation of a meltpool image captured by the imaging device 104. Meltpool characteristics can change as a function of process conditions as discussed in this specification.

The control unit 110 obtains the input data 106. In some implementations, the input data 106 includes a representation of a volume of molten material. For example, the input data 106 can include a meltpool signature from a dual wavelength pyrometer representing a portion of the part 103 where the laser 102a was focused. The laser 102a can cause powder of the powder bed 102b to fuse together to create the part 103. The input data 106 can include representations of one or more meltpools and one or more ejecta from the one or more meltpools.

The control unit 110 performs operations of one or more engines or modules, such as an extraction engine 112, a machine learning model 114, and defect determination module 116. The extraction engine 112 of the control unit 110 extracts one or more features from the input data 106. In some implementations, the extraction engine 112 extracts portions of the input data 106 corresponding to a meltpool body and meltpool ejecta. For example, the extraction engine 112 can crop a portion of the input data 106, such as an image representing a volume of molten material, to exclude portions of the input data 106 that do not represent a volume of molten material, such as portions that do not include either ejecta or a meltpool body.

The extraction engine 112 determines, using the input data 106, one or more features to provide to the machine learning model 114. In some implementations, the extraction engine 112 determines to extract 4 features representing meltpool body temperature and shape and ejecta temperature and shape, as discussed herein. For example, the extraction engine 112 can generate one or more values for each feature that represent the feature. The extraction engine 112 can provide the corresponding values to the machine learning model 114 for processing.

The machine learning model 114 obtains values representing features from the extraction engine 112. The machine learning model 114 can be trained, e.g., by the control unit 110, to output one or more indications of defects or predicted defects based on input features. For example, in a training process, the control unit 110 can provide features to the machine learning model 114 corresponding to parts that have already been analyzed using one or more various techniques, such as x-ray or other analyses, to determine ground truth defects. The machine learning model 114 can predict a defect in the part. The control unit 110 can compare the prediction of the machine learning model 114 with the ground truth defects to determine one or more error terms. The control unit 110 can use the one or more error terms to adjust one or more parameters or weights in the machine learning model 114. In general, the control unit 110 can adjust elements of the machine learning model 114 to make predictions more accurate and agree with subsequent training data. Techniques such as backpropagation can be used.

In some implementations, the machine learning model 114 is trained to detect type and severity of defects. For example, the control unit 110 can provide features corresponding to parts with known types and severities of defects. The machine learning model 114 can predict types and defects of severities using the provided features. The control unit 110 can obtain the output of the machine learning model 114 indicating one or more types of defects and one or more severities for a part with known types and severities of defects. The control unit 110 can obtain one or more values indicating the known types and severities of defects for the part (e.g., from a database communicably connected to the control unit 110). The control unit 110 can compare the predictions from the machine learning model 114 to the known types and severities to generate one or more error terms. The control unit 110 can then use the one or more error terms, as discussed, to adjust one or more parameters or weights of the machine learning model 114.

The machine learning model 114 generates one or more output values indicating one or more defects. The machine learning model 114 can provide one or more values indicating output to the defect determination module 116. The defect determination module 116 determines a defect using the output of the machine learning model 114. In some implementations, the machine learning model 114 provides values directly indicating a type or severity of a defect. For example, the defect determination module 116 can be a part of the machine learning model 114.

The defect determination module 116 generates the defect 118. In some implementations, the control unit 110 determines feedback 120 for the system 102 using the defect 118. For example, the control unit 110 can determine, using the defect 118, that a scanning speed is too slow, a laser power is too high, among other parameters discussed herein. In some implementations, the control unit 110 operates an algorithm that provides corresponding feedback for specific types of defects. For example, for a keyhole defect, reduce laser power in proportion to a severity indicating by the defect 118 and increasing scanning speed in proportion to a severity indicating by the defect 118. For other defects, the control unit 110 can generate other feedback.

In general, the control unit 110 can configure the feedback 120 to cause the system 102 to change a processing of the part 103 of subsequent part. In some implementations, the defect 118 indicates that the defect will occur in a future time. The control unit 110 can configure the feedback 120 to adjust one or more parameters of the system 102 at the future time to prevent the defect from occurring.

In some implementations, the imaging device 104 is off axis from the laser 102a. In some implementations, the imaging device 104 uses a mirror to view a surface of the part 103 being processed by the system 102.

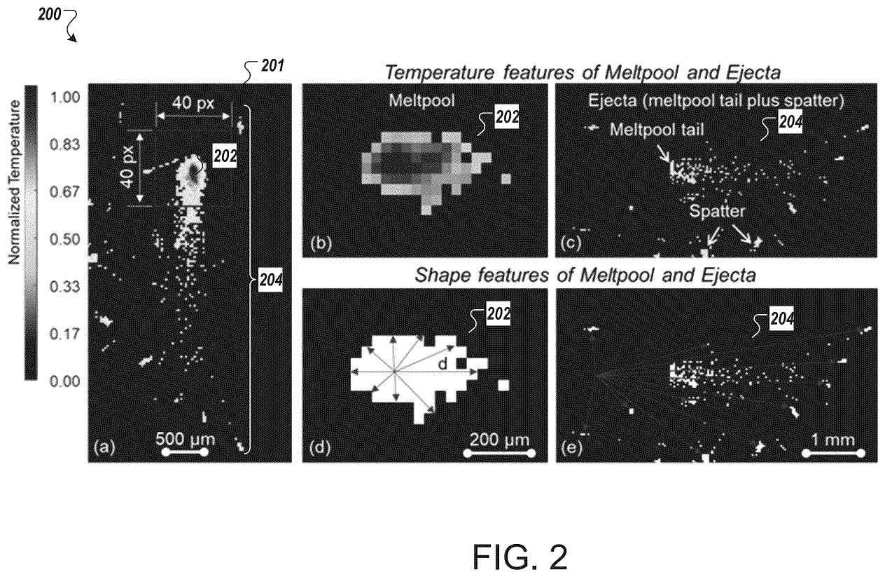

FIG. 2 shows an example separation of meltpool body and ejecta using image processing. Panel (a) of FIG. 2 shows an original image (e.g., an image captured by the imaging device 104 for the input data 106 shown in image 108), where a meltpool body is indicated by a square of 40×40 pixels. Panels (b) and (c) of FIG. 2 show separated meltpool and ejecta images, respectively, used for extracting temperature-based features. Panels (d) and (e) of FIG. 2 are binarized meltpool and ejecta images used for extracting shape-based features. Red arrows represent Euclidean distance measured from a center of a meltpool body.

To extract features, such as meltpool signatures, the control unit 110 can separate ejecta 204 (spatter and meltpool tail) from a body of the meltpool 202. In the example of FIG. 2, the meltpool body 202 is a 40 pixel×40 pixel area with its center coincident with a hottest pixel in the meltpool as shown in FIG. 2. At this spatial resolution, the meltpool body 202 is approximately 1160 μm×1160 μm. The rest of image 201 is considered part of the ejecta 204.

In some implementations, the image 201 is further processed. For example, the image 201 can be processed using K-means image segmentation. Further processing can be used (e.g., by the control unit 110) to segment a meltpool body into clusters (e.g., 3) based on values of the image 201, such as intensity. A cluster belonging to a hottest region of the meltpool can be considered as the final meltpool 202, shown in panel (b) of FIG. 2. In some implementations, K-means image segmentation is implemented in MATLAB.

In some implementations, the data shown in FIG. 2 is included in the input data 106 of FIG. 1. The control unit 110 can extract physically intuitive meltpool and spatter morphology (shape) and temperature distribution signatures from the input data 106. FIG. 2 shows examples of temperature features of meltpool (panel (b) of FIG. 2) and ejecta (panel (c) of FIG. 2) and shape features of meltpool (panel (d) of FIG. 2) and ejecta (panel (be) of FIG. 2). The control unit 110 can extract features, such as the temperature features and shape features, and provide the features to the machine learning model 114 as described in FIG. 1.

Panels (b) and (c) of FIG. 2 are representative meltpool and ejecta images, respectively, for temperature-based signatures. Panels (d) and (e) of FIG. 2 are corresponding binarized (black-and-white) images used for morphology-based signatures. In some implementations, for morphology or shape-based features, the Euclidean distance from a center of the meltpool 202 to edge pixels and ejecta pixels is used (indicated by red arrows shown in panels (d) and (e) of FIG. 2). In some implementations, for temperature-based features, the normalized temperature values of all pixels belonging to the meltpool 202, and ejecta 204 are computed. The meltpool temperature can be normalized from 0 to 1 to aid machine learning models (e.g., the machine learning model 114) and facilitate generalizability of the approach described across different materials.

In some implementations, one or more features are extracted to capture meltpool characteristics. For example, in one case, a total of four physics-informed meltpool and ejecta features are used to capture meltpool characteristics for each segment representative of a processing condition. The rationale for selection of these features based on literature and the approach to estimate these from the pyrometer images are described.

Features extracted by the control unit 110 can include one or more of the following: meltpool length, mean ejecta spread, mean ejecta temperature, distribution of meltpool temperature, among others.

In some implementations, the control unit 110 determines a length from a meltpool captured by an image of the imaging device 104. A meltpool length (Lₘ) can be defined as twice a largest distance from a center of a meltpool to its edge. This distance is visually depicted in panel (d) of FIG. 2. In some implementations, the control unit 110 calculates the distance from each frame of a meltpool image obtained from the imaging device 104 as follows Lₘ=2dₘₐₓ where dₘₐₓ is the largest Euclidean distance from the center of meltpool to its edge. In some implementations, the control unit 110 compares one or more determined distances to determine a maximum distance. Meltpool length can be related to part quality so can be important as a feature of defect detection. Elongated meltpools can separate into discrete meltpools. These discrete meltpool parts can fail to completely coalesce on solidification, resulting in incomplete fusion, and subsequent formation of porosity or other defects. Thus, the meltpool length is considered an important indicator of the process regime in LPBF.

In some implementations, the control unit 110 extracts a spread from ejecta of a meltpool captured by an image of the imaging device 104. The control unit 110 can generate a mean ejecta spread. The mean ejecta spread (Sₑ) feature can capture a distance travelled by ejecta particles and represents a spatial distribution (spread) of spatter particles. In some implementations, the spread is quantified as an average distance measured from a center of the meltpool (e.g., the meltpool 202) to every ejecta pixel as indicated by arrows in panel (e) of FIG. 2. Ejecta can be determined as part of a meltpool other than the body (1160 μm×1160 μm). The mean ejecta spread is estimated as follows,

$${S}_{e} = \frac{1}{n} {\sum }_{i = 1}^{n} {d}_{i}^{e}$$

where n is the total number of nonzero ejecta pixels and dᵢ^{e} is the Euclidian distance from meltpool center to the i^{th} ejecta pixel.

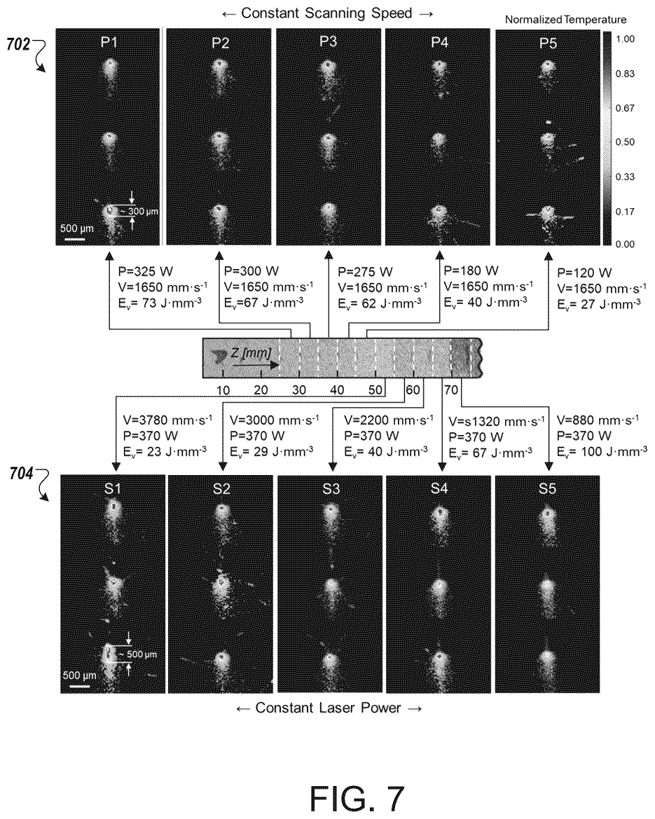

For example, examining S1-S5 in bottom row of FIG. 7, ejecta spread decreases with decrease in scanning speed. Thus, Sₑ captures an average distance travelled by each ejecta particle. Based on key findings concerning the ejecta distribution, quantity, and induced flaw formation from the literature, spread of ejecta (Sₑ) can be used as a feature for detecting defects, such as types of porosity. For example, ejecta particles can disturb a meltpool stability and result in lack-of-fusion porosity.

In some implementations, the control unit 110 determines a mean ejecta temperature using detected ejecta from a meltpool captured by an image of the imaging device 104. The mean ejecta temperature (Tₑ) can represent an average temperature of ejecta as shown in panel (c) of FIG. 2. Mean ejecta temperature can be calculated (e.g., by the control unit 110) as follows:

$${T}_{e} = \frac{1}{n} {\sum }_{i = 1}^{n} {T}_{i}$$

where n is the total number of nonzero ejecta pixels and Tᵢ is the temperature of i^{th} pixel. In some cases, the temperature of ejecta is closely associated with the onset of meltpool instability, which is also contingent on material type and is influenced by partial vapor pressures of elements that compose the material.

In some implementations, the control unit 110 determines a distribution of meltpool temperature from a meltpool captured by an image of the imaging device 104. In some implementations, the temperature distribution of a meltpool region (see panel (b) of FIG. 2) is quantified in terms of its skewness (e.g., third moment of the mean). For example, the temperature distribution of a meltpool region can be quantified as follows

$$S {k}_{m} = \frac{\frac{1}{m} {\sum }_{i = 1}^{m} {( {T}_{i} - μ )}^{3}}{{σ}^{3}} ,$$

where μ is the mean of meltpool temperature, σ is the standard deviation of meltpool temperature and m is the total number of nonzero pixels in the meltpool temperature image.

The skewness feature captures a symmetry of the meltpool temperature distribution about the mean. The temperature distribution of a meltpool can be symptomatic of meltpool instability and consequently relates to flaw formation.

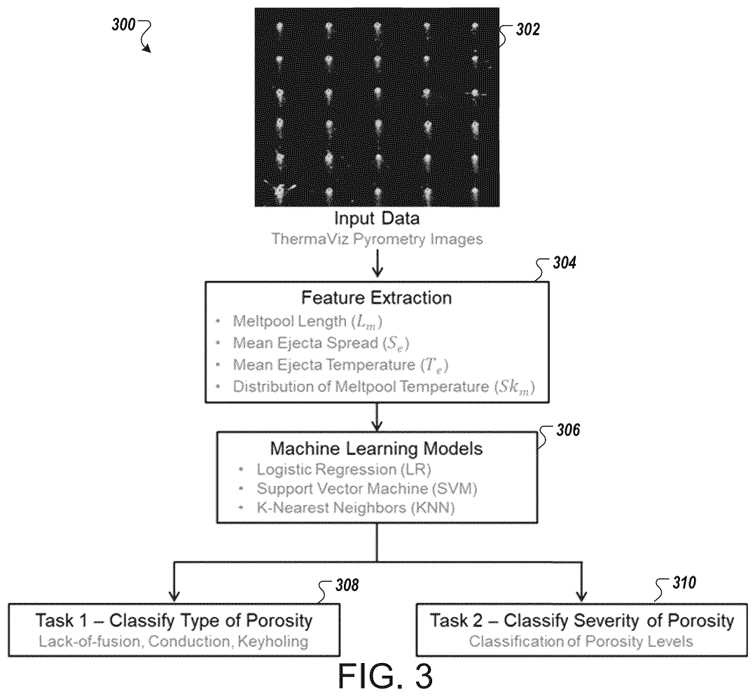

FIG. 3 Schematic representation of data processing and machine learning approach used in this work for classifying severity and type of porosity.

The process 300 is similar to processes shown in FIG. 1. For example, input data 302 can be an example of the input data 106, feature extraction 304 can be an example of the extraction engine 112, machine learning models 306 can be an example of the machine learning model 114, classifying a type of porosity 308 and classifying a severity of porosity 310 can be examples of actions performed by the defect determination module 116.

Meltpool features described can be used as inputs to supervised machine learning models (e.g., the machine learning model 114). The machine learning models can be trained towards one or more tasks. For example, a first task can include detection of a type of porosity or process regime (e.g., lack-of-fusion, conduction, keyhole formation). A second task can include classification of a severity of porosity. Some example machine learning-based classification tasks are summarized in the following table 1.

TABLE 1
Task 1 - Classify Type of Porosity (Process Regime)

| | |
|---|---|
| Classifi- | Number of |
| cation | Meltpool |

| | | |
|---|---|---|
| Level | Porosity Mode | Images Per Class |

| | | | |
|---|---|---|---|
| 3-way | 1. | Lack-of-fusion porosity | 3,500 |
| | 2. | Conduction mode (ideal | |
| | | case, minimal porosity) | |
| | 3. | Keyhole formation | |

Task 2 - Classify Severity of Porosity

| | | | Number |
|---|---|---|---|
| | | | of |
| Classifi- | | | Meltpool |
| cation | | | Images |
| Level | Severity of Porosity | | Per Class |
| 2-way | 1. | Nominal (DVR = 0.00%, and ρᵣₑₗ ≥ 99%) | 10,000 |
| | 2. | Porous (DVR > 0.00%, and ρᵣₑₗ ≥ 86%) | |
| 3-way | 1. | Nominal (DVR = 0.00%, and ρᵣₑₗ ≥ 99%) | 5,600 |
| | 2. | Medium (0.08% < DVR ≤ 0.61%, and ρᵣₑₗ ≥ | |
| | | 93%) | |
| | 3. | High (DVR > 1.00%, and ρᵣₑₗ ≤ 90%) | |
| 4-way | 1. | Nominal (DVR = 0.00%, and ρᵣₑₗ ≥ 99%) | 5,600 |
| | 2. | Low (0.00% < DVR ≤ 0.08%, and ρᵣₑₗ ≥ | |
| | | 97%) | |
| | 3. | Medium (0.08% < DVR ≤ 0.61%, and ρᵣₑₗ ≥ | |
| | | 93%) | |
| | 4. | High (DVR > 1.00%, and ρᵣₑₗ ≤ 90%) | |
| 5-way | 1. | Nominal (DVR = 0.00%, and ρᵣₑₗ ≥ 99%) | 3,000 |
| | 2. | Low (0.00% < DVR ≤ 0.08%, and ρᵣₑₗ ≥ | |
| | | 97%), | |
| | 3. | Medium (0.08% < DVR ≤ 0.61%, and ρᵣₑₗ ≥ | |
| | | 93%) | |
| | 4. | High (0.61% < DVR ≤ 1.38%, and ρᵣₑₗ ≥ | |
| | | 90%) | |
| | 5. | Very High (1.38 < DVR ≤ 1.96%, and ρᵣₑₗ ≥ | |
| | | 86%) | |

In some implementations, the machine learning classification models used are basic supervised machine learning models, such as K-Nearest Neighbors (KNN), Support Vector Machine (SVM), and logistic regression (LR). In some implementations, models that are easy to implement and are tractable can be used. For example, KNN is considered one of the more simple machine learning classification models, with no complex activation function and computation of chain derivatives as with neural networks. Because of its more simple construction, a KNN can be implemented with rudimentary computational processing, such as processing on board a LPBF machine which may have sparse computational resources.

In some implementations, machine learning models discussed herein include CNNs. However, CNNs may require more processing power and therefore, along with other process intensive networks, may not be suitable for processing on board a LPBF or other system for additive manufacturing.

In some implementations, machine learning models are trained and tested using a 4-way pore severity classification. For example, a total of 22,400 data points (meltpool images) can be obtained (e.g., 5600 data points per class). Out of these, 17,920 data points (e.g., 80%) were used to train and validate models and the remaining 4480 data points are used for testing. For hyperparameter optimization, a 5-fold cross-validation and sequential Bayesian optimization schema can be used. Accuracy of prediction for various machine learning models can be quantified in terms of an F1-score, which ranges between 0 and 1 (highest accuracy); false positive rate (FPR, Type I error rate); and false negative rate (FNR, Type II error rate).

The type of porosity can be classified into three modes: lack-of-fusion, conduction mode (ideal case, minimal porosity), and keyhole formation based on optical and scanning electron microscopy. Depending on a volume of porosity detected in the part in terms of defect volume ratio (DVR from XCT) and Archimedes relative density (ρ_rel), the severity of porosity can be discretized into different levels. The discretization can range from a 2-way (high and low) classification to higher resolution 5-way classification.

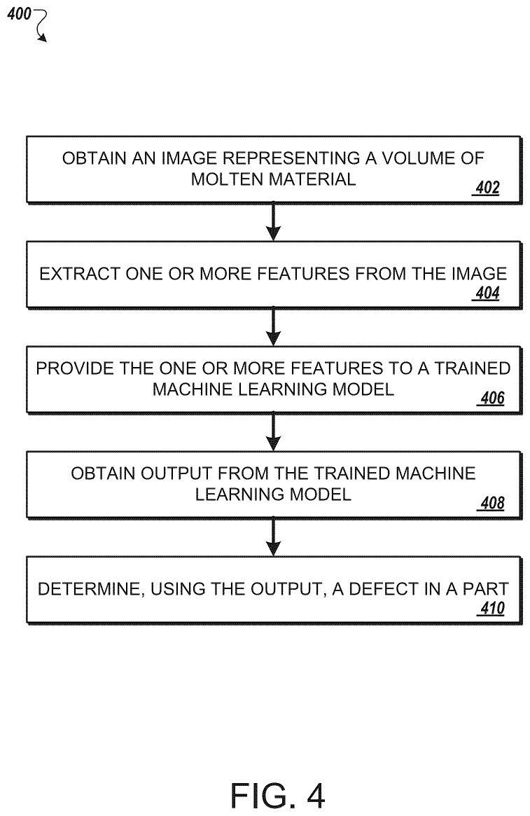

FIG. 4 is a flow diagram illustrating an example of a process 400 for additive manufacturing defect detection. The process 400 may be performed by one or more electronic systems, for example, the system 100 of FIG. 1.

The process 400 includes obtaining an image representing a volume of molten material (402). For example, the control unit 110 can obtain the input data 106. The input data 106 can include a representation of a volume of molten material. The molten material can be a portion of the part 103 that was heated by the laser 102a, e.g., during manufacturing of the part 103.

The process 400 includes extracting one or more features from the image (404). For example, the extraction engine 112 of the control unit 110 can extract one or more features from the input data 106. The one or more features can include one or more values representing a meltpool body temperature and shape and ejecta temperature and shape, as discussed herein.

The process 400 includes providing the one or more features to a trained machine learning model (406). For example, the control unit 110 can provide output from the extraction engine 112 indicating one or more values representing features extracted from the input data 106, to the machine learning model 114.

The process 400 includes obtain output from the trained machine learning model (408). For example, the machine learning model 114 can be trained to detect type and severity of defects. The machine learning model 114 can generate one or more output values indicating one or more defects in the part 103 or to be generated in the part 103 using information representing current process parameters from the system 102.

The process 400 includes determining, using the output, a defect in a part (410). For example, the defect determination module 116 can determine a defect using the output of the machine learning model 114. The output of the machine learning model 114 may include one or more values, e.g., of a vector or matrix. The defect determination module 116 can determine, based on the one or more values, an associated defect type or severity. In some implementations, the machine learning model 114 provides values directly indicating a type or severity of a defect. For example, the defect determination module 116 can be a part of the machine learning model 114.

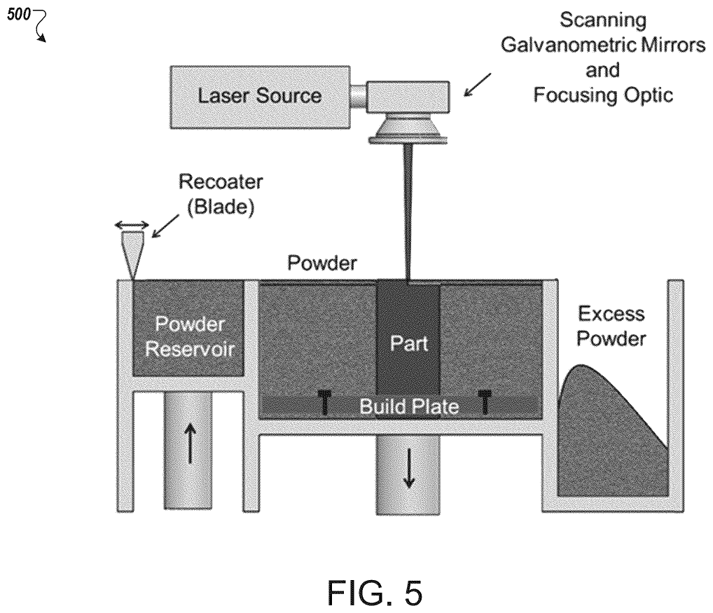

FIG. 5 is an example representation of a laser powder bed fusion (LPBF) additive manufacturing process 500. In laser powder bed fusion (LPBF) additive manufacturing, energy from a laser beam is used to selectively fuse powder particles to produce three-dimensional objects in a layer-by-layer manner. A schematic representation of the LPBF process is shown in FIG. 5. The process can produce geometries which are difficult, if not impossible, to make using traditional subtractive and formative processes. Despite the potential of LPBF to overcome the material and design barriers of traditional manufacturing, safety-critical industries such as aerospace are reticent in adopting the process due to the lack of part consistency and tendency of the process to create flaws. Uncertainty in part quality can lead to large variation in functional properties.

Some of the quality-related challenges in LPBF include porosity, microstructure inhomogeneity, cracking, among others, that result from substandard powder feedstock, improper selection of the process parameters, and unsuitable design of the part. Optimizing process parameters to minimize flaw formation using empirical design of experiments can be both expensive and time consuming. Further, an experimentally derived processing window may not transfer to different parts built with the same material and using the same equipment because flaw formation in additive manufacturing, such as LPBF, can depend on part design, build orientation, presence of support structures, among others. Moreover, despite extensive process optimization, flaw formation in LPBF can be liable to occur on account of stochastic (chance-related) factors, such as presence of ejecta (spatter) from the process. In-process monitoring of build quality using data acquired from in-situ sensors can help detect defects and reduce, through feedback control systems, occurrence of defects during manufacturing.

In some implementations, the control unit 110 detects and predicts a type and severity of porosity in a manufactured part (e.g., part 103) using meltpool signatures acquired from the imaging device 104. Porosity can significantly degrade the functional properties of the part, such as its fatigue life, and compromise its structural integrity. To explain further, the meltpool is the region where a laser melts powder to create a dynamic volume of molten material, typically 50 to 100 μm in depth or width, and close to one millimeter in length. The complex thermal and fluid flow phenomena of the meltpool influences the microstructure evolved and flaw formation, including porosity, in LPBF.

In general, LPBF-processed parts are expected to exceed 99% of the theoretical density of the material to be considered functionally deployable. In some implementations, the control unit 110 extracts physics-informed features from meltpool images e.g., based on theoretical simulations and experimental observations reported in the literature. The control unit 110 can use these features to predict a type and severity of pore formation using a relatively simple, readily implemented and computationally tractable machine learning models, such as K-Nearest Neighbors. The underlying principle is that a small set of pragmatic, physics-informed features extracted from meltpool data when used with simple machine learning models will detect part flaws at par with, or exceeding, a complex and computationally intensive deep machine learning model that uses raw meltpool images.

From a practical perspective, it is important to detect both severity (amount) of porosity and its nature (type) to aid process correction. This can be important not only in LPBF, but also in other additive manufacturing processes, such as wire and arc additive manufacturing. To explain further, in LPBF, and metal-based additive manufacturing processes in general, the type of porosity can be classified into three broad categories contingent on the causal process phenomena, these are: (i) lack-of-fusion, (ii) keyhole formation, and (iii) gas porosity. Lack-of-fusion pores are characterized by their irregular (acicular) shape and can be caused by partial fusion of powder material on account of insufficient input energy. In contrast to lack-of-fusion porosity, keyhole pores can be caused by vaporization of material due to excessive input energy and are typically circular in appearance. The third category of porosity called gas porosity, is typified by circular shaped pores which can result either from voids present in the feedstock material, or gasses escaping from the meltpool. Given their large size and irregular size, lack-of-fusion pores can be comparatively more detrimental to functional integrity. In general, this description focuses on lack-of-fusion and keyhole porosity, however, other defects can be detected using processes described.

In some implementations, a manufactured part can be a large cuboid (e.g., 10 mm×10 mm×137 mm, shown graphically as part 103 in FIG. 1). In some implementations, a system, such as the system 100 varies process conditions. For example, the system 100 can build the part 103 with varying processing conditions contingent on a build height. A material of the part 103 can be ATI 718Plus alloy powder with a particle size in the range of 10-60 μm. The chemical composition of the powder is shown in table 2 below (Nominal chemical composition (wt. %) of ATI 718Plus alloy):

TABLE 2

| | Chemical Composition (wt. %) | | | | | | | | | |
|---|---|---|---|---|---|---|---|---|---|---|
| Alloy | Ni | Cr | Fe | Co | Nb | Mo | Al | W | Ti | C |
| ATI | Balance | 17.7 | 9.59 | 9.19 | 5.62 | 2.51 | 1.58 | 1.00 | 0.78 | 0.020 |
| 718Plus | | | | | | | | | | |
| Powder | | | | | | | | | | |

The ATI 718Plus alloy is a modified version of Inconel 718, in which Co is replaced with ½ of its Fe-content, 1wt.% W is added, and Al/Ti ratio is increased. This modification increases the service temperature of the ATI 718Plus alloy and improves its mechanical properties.

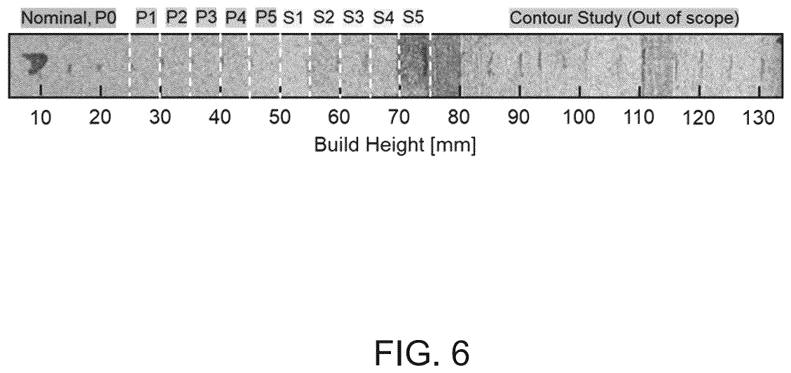

In some implementations, one or more process parameters are varied. For example, laser power (P) and scanning speed (V) can be varied (e.g., by the control unit 110 or other element of the system 100) at different build heights. FIG. 6 and table 3 below summarize some experimental conditions (e.g., process parameters used for LPBF process parameter variations).

TABLE 3
Process parameters used for LPBF process parameter variations.

| | | Laser | Scanning | Hatch | Build | |
|---|---|---|---|---|---|---|
| | | Power | Speed | Spacing | Height | Layer |
| Process Step | | P [W] | V [mm · s−1] | H [mm] | T [mm] | Number |
| Nominal, P0 | | 300 | 1650 | 0.09 | 0-25 | 1-833 |
| Variation | P1 | 325 | 1650 | 0.09 | 25-30 | 833-1000 |
| in | P2 | 300 | | | 30-35 | 1000-1167 |
| Laser | P3 | 275 | | | 35-40 | 1167-1333 |
| Power | P4 | 180 | | | 40-45 | 1333-1500 |
| | P5 | 120 | | | 45-50 | 1500-1667 |
| Vari [symbol] | S1 | 370 | 3780 | 0.14 | 50-55 | 1667-1833 |
| | S2 | | 3000 | | 55-60 | 1833-2000 |
| | S3 | | 2200 | | 60-65 | 2000-2167 |
| | S4 | | 1320 | | 65-70 | 2167-2333 |
| | S5 | | 880 | | 70-75 | 2333-2500 |

[symbol]

indicates data missing or illegible when filed

By varying process parameters, the system 100 can generate different types of porosity (lack-of-fusion and keyhole) with varying level of severity. In general, the laser power (P) and scanning speed (V), along with layer height (T) and hatch spacing (H) are typically the most consequential to flaw formation. The effect of varying these parameters on the type and severity of porosity is discussed herein. In some implementations, to help train or test a detection process, it may be advantageous to build one tall part instead of several smaller parts. In additive manufacturing, such as LPBF, the location of the part on the build plate is known to have a significant effect on part quality. Hence, to mitigate the effect of part location, instead of processing several small samples each under a different process condition, the system 100 can build one part with processing conditions changed at different layers, as shown in FIG. 6. In some implementations, the building of a part and corresponding collected data, can be used as training data by the system 100 for training the machine learning model 114.

Referring to FIG. 6 and Table 3, the system 100 can start a build with a nominal condition, labeled P0, processed with laser power (P) 300 W, and scanning speed (V) 1650 mm·s⁻¹. These nominal conditions are recommended by the powder supplier (ATI) based on empirical studies. The processing can continue under nominal conditions for 25 mm (layer 0-833). For the entirety of the process, the layer thickness (T) can be fixed at 30 μm and a rectilinear scanning strategy with 90° shift between successive layers can be followed.

The next 25 mm (layer 833-1667) of the part, labeled P1-P5 in FIG. 6, was built with laser power (P) varying from 120 W to 325 W with scanning speed (V) fixed at 1650 mm·s⁻¹. We note that P2 is identical to the nominal condition (P0). From 50 mm (layer 1667) to 75 mm (layer 2500), labeled S1-S5, the laser power (P) was fixed at 370 W, the scanning speed (V) was varied from 880 mm·s⁻¹ to 3780 mm·s⁻¹, and the hatch spacing (H) was increased from 0.09 mm for P0-P5 to 0.14 mm for S1-S5. The rest of the part was built with variation of contour patterns, the effects of which are not studied in this work. In general, FIG. 6 shows a photograph of a manufactured ATI 718Plus part, demarcating segments produced under different processing parameters (shown in Table 3). This example part is 10 mm×10 mm×137 mm (build height), consisting of 4567 individual layers of 30 μm layer height.

In some implementations, the system 100, or other connected systems determine an actual severity of porosity, or other defect, to use as ground truth data for training the machine learning model 114. After processing, a processed part can be detached from the build plate using a wire electro-discharge machining. Subsequently, a severity of porosity can be quantified using non-destructive X-ray computed tomography (XCT, Nikon XTH 225 ST). The entire part can be scanned at a voxel resolution of 15 μm and the resulting XCT image slices analyzed using Volume Graphics software (VGSTUDIOMAX 3.3.4) native to the XCT machine. The level of porosity can be reported in terms of defect volume ratio (DVR) to quantify porosity; DVR can be defined as,

$$DVR [ \% ] = \frac{{\sum }_{i = 1}^{n} {v}_{i}}{{V}_{P}} \times 100 ,$$

where n is the total number of voxels belongs to porosity in a part, νᵢ is a single voxel belong to a pore detected by the XCT software, and V_{P} is the total volume of the part in voxels.

The voxel resolution of 15 μm used for XCT analysis can limit a minimum pore size that can be reliably detected to 30 μm. Apart from XCT, the system 100 can measure a relative density of each segment corresponding to the changes in laser power (P0-P5) and scanning speed (S1-S5), e.g., using the Archimedes method.

In some implementations, the system 100, or other connected systems determine an actual type of porosity, or other defect, to use as ground truth data for training the machine learning model 114. The type of porosity can be determined using optical microscopy or scanning electron microscopy. Sample preparation for microscopy analysis can include further sectioning of a part into smaller samples of 10 mm×10 mm×5 mm along a vertical height corresponding to processing segments (e.g., P1-P5, S1-S5 shown in Table 3 and FIG. 6.

Samples for each processing conditions (e.g., 10 shown in P1-P5, S1-S5) can be further cross-sectioned into two smaller sections for characterization along an XY-plane (normal to a build direction) and XZ-plane (parallel to a build direction). The resulting 20 samples after cross-sectioning can be embedded in resin, progressively ground with finer silicon carbide abrasive pads, and polished using diamond paste (3, 1, 0.5 μm) to a mirror finish. After polishing, the samples can be etched by swabbing the surface with aqua regia (HCL: HNO₃, 3:1) for approximately ten seconds.

Shown in FIG. 7 are representative examples of the meltpool images acquired from the pyrometer under various laser power (P) and scanning speed (V) conditions. The top row of FIG. 7 shows representative meltpool images acquired while varying the laser power over the segments (P1-P5). Over the segments (P1-P5), which are 5 mm tall and separated along the build height, the laser power was reduced from 325 W-120 W while the scanning speed was fixed at V=1650 mm·s⁻¹.

In FIG. 7, the power (P), scanning speed (V), layer thickness (T) and hatch spacing (H) are combined into a volumetric energy density (E_{ν}, J·mm⁻³) which can be expressed as follows:

$${E}_{v} = \frac{P}{T \cdot V \cdot H} .$$

Meltpool images obtained by an imaging device (such as the imaging device 104, imaging pyrometer, among others) are shown in FIG. 7. The images indicate that a meltpool size and shape are related to processing conditions. For example, referring to the top row 702 of FIG. 7, the meltpool size and shape remain consistent when the laser power is reduced over the segments (P1-P4) from 325 W to 180 W. Likewise, the temperature distribution of the meltpool and ejecta also remain consistent as the laser power is reduced from 325 W to 180 W. However, when the laser power was further reduced to 120 W (segment P5), the spatter becomes prominent and relatively hotter ejecta particles were observed in the areas further away from the core meltpool region.

The bottom row 704 of FIG. 7 shows representative meltpool images acquired while varying the scanning speed over the segments (S1-S5), wherein the scanning speed was reduced from 3780 mm·s⁻¹ to 880 mm·s⁻¹ and the laser power was fixed at P=370 W. For the high scanning speed conditions (V>2200 mm·s⁻¹) compared to laser power conditions (P1-P4), the meltpool is relatively elongated and the ejecta travels further from the meltpool. Likewise, the meltpool images from the higher scanning speed conditions (V>2200 mm·s⁻¹) depict hotter ejecta particles when compared with those from the lower scanning speed conditions (V≤2200 mm·s⁻¹). These observations provide a bases for extracting meltpool shape and temperature features and correlating these features to porosity type and severity as discussed.

In general, FIG. 7 shows representative meltpool images acquired using an imaging device (such as an imaging pyrometer) for build segments printed with varying laser power (top row 702) and scanning speed (bottom row 704). The meltpool shape and spatter characteristics change significantly with processing conditions. For example, comparing P1 and S1, a large increase in scanning speed at S1 (3780 mm·s⁻¹) compared to P1 (1650 mm·s⁻¹) results in prominent spatter.

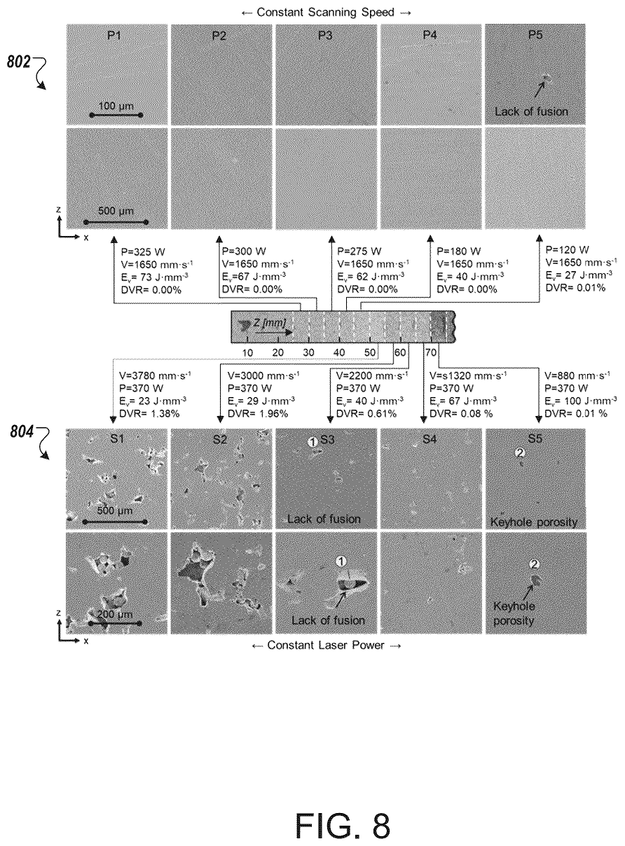

FIG. 8 (top two rows 802) show SEM images obtained in the X-Z directions of the segments (P1-P5, S1-S5) built under varying process conditions. In FIG. 8 two SEM images captured at different scales are shown for each processing condition. In context of P1-P5, pores were not observed until laser power is reduced to 120 W (P5), at which juncture a lack-of-fusion type of pore is noted. Such lack-of-fusion porosity is typically characterized by its irregular shape, and is generally caused due to insufficient energy to melt the powder.

As evident in FIG. 8 (bottom two rows 804), lack-of-fusion porosity increases proportionally to scanning speed due to decrease in the energy density (E_{ν}). In the scanning speed range of 2200 mm·s⁻¹ (S3) to 3780 mm·s⁻¹ (S1) (E_{ν}, 23 to 40 J·mm⁻³) lack-of-fusion porosity is prominent. Apart from their characteristic irregular shape, partially melted powder particles are observed in the voids in the bottom two rows 804 of FIG. 8.

On decreasing the scanning speed to V=1320 mm·s⁻¹ with P=370 W, which corresponds to an increased energy density (E_{ν}=67 J·mm⁻³), lack-of-fusion porosity can be largely eliminated. However, with a further reduction in scanning speed to V=880 mm·sec⁻¹, resulting in E_{ν}=100 J·mm⁻³ in segment S5 (the highest level of E_{ν} in this work), keyhole type porosity was observed. Keyhole porosity forms at high energy density levels as the laser penetrates deeper into the deposited material, causing material to vaporize. The resulting cavity in the part collapses, causing a pore typically in the range of 30-50 μm. Thus, the scanning speed experiments manifest in transition of porosity from lack-of-fusion to keyhole porosity. While such high energy density values can cause both keyhole porosity and gas porosity, however, under high-resolution scanning electron microscopy, the pores in region S5, shown in FIG. 8, were observed to have an irregular shape characteristic of keyhole formation, as opposed to the uniform circular shape typical of gas porosity.

In general, FIG. 8 shows (top row 802) SEM images of the XZ-cross sections of the segments processed under varying laser power while the other processing parameters maintained constant (V=1650 mm·s⁻¹, H=0.090 mm, and T=0.030 mm). The porosity content corresponding to different laser powers remains insignificant while in the laser power range of 325 W to 180 W (P1-P4). Lack-of-fusion pores are observed in the segment P5 processed at a lower laser power (120 W). (bottom row 804) SEM images of the XZ-cross sections of the segments processed under varying scanning speed while the other processing parameters maintained constant (P=300 W, H=0.140 mm, and T=0.030 mm). Segments S1-S3 processed under very high scanning speed (3000-3780 mm·s⁻¹) are replete with large lack-of-fusion pores. The porosity is mitigated as the scanning speed is reduced. Keyhole pores are observed in the S5 segment processed at the lowest scanning speed (880 mm·s⁻¹).

The severe lack-of-fusion porosity observed at the highest scanning speed range of 2200 mm·s⁻¹ (S3) to 3780 mm·s⁻¹ (S1) can be explained by a phenomena called balling, which is a result of meltpool instability due to the Plateau-Rayleigh effect. Considering a deposition track as cylinder of liquid metal with diameter D and length L, the condition for Plateau Rayleigh meltpool instability can be satisfied when L/D>π. Under this condition, the meltpool track breaks down into small droplets to minimize its surface energy.

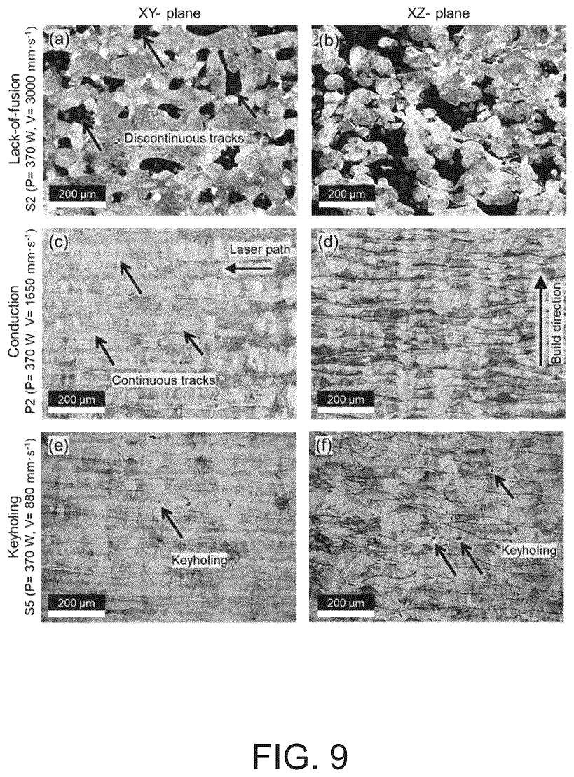

To explain these observations further, FIG. 9 compares optical micrographs of individual samples from three modes of processing conditions as observed from XY- and XZ-planes: severe lack-of-fusion, represented by high-speed processing condition S2 (P=370 W, V=3000 mm·s⁻¹, panel (a) and (b) of FIG. 9); conduction mode, represented by nominal processing condition P0 (P=370 W, V=1650 mm·s⁻¹, panel (c) and (d) of FIG. 9); and keyholing mode, represented by low scanning speed processing condition S5 (P=370 W, V=880 mm·s⁻¹, panel (e) and (f) of FIG. 9). During the processing of segment S5, referring to panel (f) of FIG. 9, the pores are observed to form near the bottom of the meltpool track, and have an irregular funnel-like shape characteristic of keyhole formation.

While continuous meltpool tracks are observed for both the nominal (panel (c) and (d) of FIG. 9) and keyholing regime (panel (e) and (f) of FIG. 9), partial fusion of tracks is noticed for the lack-of-fusion mode (panel (a) and (b) of FIG. 9). The scanning speed can be related to the viscosity of melt track during solidification. The reduced energy density at high scanning speed can result in a viscous meltpool that does not flow sufficiently to wet the adjacent tracks. Subsequently, powder in a layer may not be uniformly melted resulting in lack-of-fusion porosity. Similarly, severe lack-of-fusion porosity can be attributed to meltpool instability, which increases with scanning speed and results in discontinuous tracks and violent ejecta.

In general, FIG. 9 shows optical microscopy images of an LPBF-processed ATI 718Plus alloy: panel (a) and (b) are optical images in the XY- and XZ-planes, respectively, of segment S2 (P=370 W, V=3000 mm·s⁻¹). This condition represents severe lock-of-fusion porosity due to balling effect. Panel (c) and (d) are the optical images of segment P2 (P=300 W, V=1650 mm·s⁻¹) in the XY- and XZ-planes, respectively. This condition is a representative of the ideal conduction mode, where continuous tracks are observed along the laser path with no porosity detected. Finally, panel (e) and (f) are the optical images of segment S5 in the XY- and XZ-planes, respectively, in which keyhole porosity is observed.

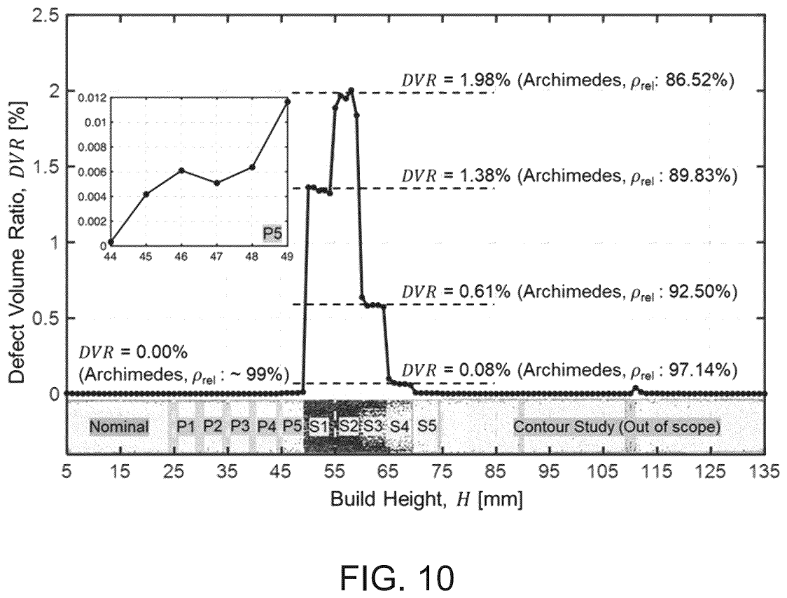

The severity of porosity observed in the test part from the XCT is summarized in FIG. 10. The porosity level in term of the defect volume ratio (DVR) for this work ranges from 0% to 2%. The highest variation in DVR is observed in the segments (S1-S5), where the laser scanning speed was varied. In this work, the effect of laser power on porosity density (P1-P5) was found to be insignificant in comparison with scanning speed, except for the segment P5, where the laser power is greatly reduced to 120 W as shown in the inset of FIG. 10. In segment P5 the porosity is observed to be 0.01%. Summarized in FIG. 10 are also the relative density measurements from the Archimedes method (ρᵣₑₗ), which ranges from ˜99% to 86.5%.

In general, FIG. 10 shows an XCT analysis of a part showing the effect different processing parameters on the overall defect volume ratio (DVR) and relative density (ρᵣₑₗ). Four clusters of part porosity are evident.

The DVR and relative density (ρᵣₑₗ, Archimedes) are reported in Table 4. Based on these, the severity of porosity can be divided into multiple discrete categories. For example, in FIG. 10 the porosity can be demarcated into four classes, as Nominal (DVR=0.00%, ρᵣₑₗ≥99%), (0.00%<DVR 0.08%, ρᵣₑₗ≥97%), Medium (0.08%<DVR≤0.61%, ρᵣₑₗ≥93%), and High (DVR>1.00%, ρᵣₑₗ: ≤90%). To further elucidate these observations, the effect of volumetric energy density on severity of porosity is discussed. For ease of explanation, analysis is focused on the 4-way classification of pore severity demarcated in FIG. 10 and Table 4.

Practitioners often use E_{ν} as an approximate guide to set LPBF process parameters for a material class with the aim of mitigating porosity. However, E_{ν} is affected by other factors beyond the main process parameters, such as laser spot size, scan strategy, gas flow, material properties, and the size of powder particles, which limit its transferability between different materials, processing conditions, and machines. To mitigate porosity formation, E_{ν} should be sufficiently large (contingent on the type of material) to achieve complete melting and fusion of the powder particles. When the E_{ν} is inordinately low, lack-of-fusion porosity is observed as explained in the context of FIG. 8. Likewise, very high E_{ν} should be avoided to prevent vaporization of the material and entrapment of gases, which lead to gas (pinhole) porosity and keyhole porosity, respectively. However, it should be noted that porosity formation in LPBF process is a function of several factors beyond process parameters. Material characteristics, build condition, part shape, location of the part on the build plate, among others, are linked to porosity formation. Hence, E_{ν} alone is an insufficient quantifier of porosity.

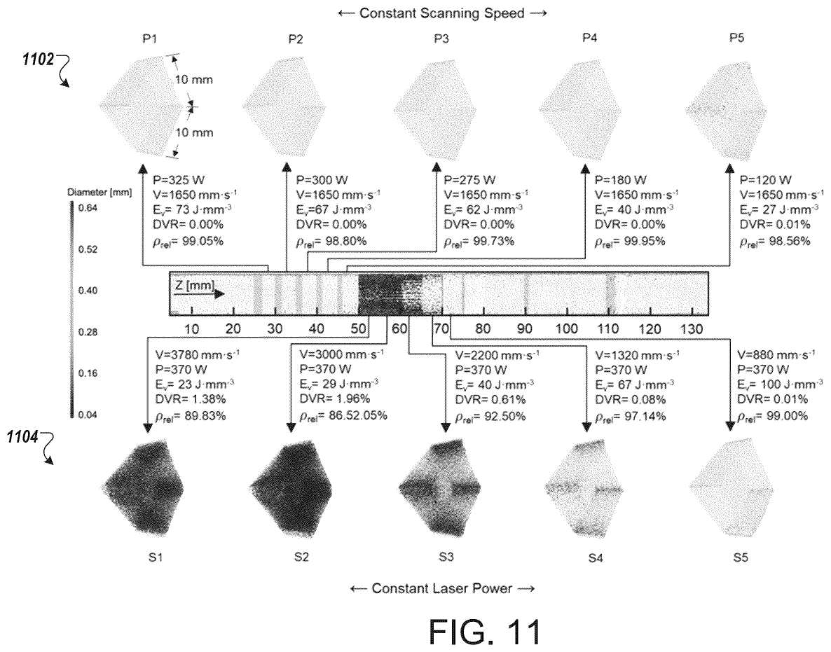

The effect of on porosity is shown in FIG. 11 in terms of XCT volumetric analysis. The top row 1102 of FIG. 11 corresponds to segments P1-P5 where the laser power (P) was decreased from 325 W to 120 W, while keeping the scanning speed (V) constant at 1650 mm·s⁻¹. Consequently, decreases proportionally from 73 J·mm⁻³ at 325 W to 27 J·mm⁻³ at 120 W. No significant porosity is observed in the build (DVR=0.00%) when using a laser power between P=325 W (73 J·mm⁻³) to 180 W (40 J·mm⁻³). However, pores appear with decrease in laser power to P=120 W, which corresponds to an E_{ν}=26 J·mm⁻³, resulting in a DVR=0.01%.

| | | Laser | | | Archimedes | XCT Defect |
|---|---|---|---|---|---|---|
| | | Power | Scanning | Hatch | Relative | Volume |
| | | P | Speed | Spacing | Density, | Ratio, DVR |
| Process Step | | [W] | V [mm × s⁻¹] | H [mm] | ρᵣₑₗ [%] | [%] |
| Nominal | | 300 | 1650 | 0.09 | 99.285 | 0 |
| Variation | P1 | 325 | | | 99.054 | 0 |
| in | P2 | 300 | | | 98.796 | 0 |
| Laser | P3 | 275 | | | 99.733 | 0 |
| Power | P4 | 180 | | | 99.947 | 0 |
| | P5 | 120 | | | 98.564 | 0.01 |
| Variation | S1 | 370 | 3780 | 0.14 | 89.833 | 1.38 |
| in | S2 | | 3000 | | 86.522 | 1.96 |
| Scanning | S3 | | 2200 | | 92.504 | 0.61 |
| Speed | S4 | | 1320 | | 97.142 | 0.08 |
| | S5 | | 880 | | 98.997 | 0.01 |

Table 4: showing Archimedes measurements corresponding to the defect volume ratio (DVR) for each processing condition (section) of the part, corresponding to FIG. 10.

In a similar vein, from the bottom row 1104 of FIG. 11 it is observed that an increase in the scanning speed, which reduces Eᵥ, leads to an increase in the porosity level. For example, the scanning speed setting of V=3000 mm·s⁻¹ with P=370 (S2), corresponding to E_{ν}=29 J·mm⁻³ results in a DVR of nearly 1.96%. An insight from FIG. 11 is that the porosity level in the build is generally mitigated by reducing the scanning speed and consequently increasing the energy density. Another observation from FIG. 11 is that the majority of the pores are concentrated within a distance of 3 mm near the edges. This is because, the central area of an LPBF part is generally at an elevated temperature compared to the edges, which facilities fusion of powder particles and thereby mitigates the lack-of-fusion porosity. Concentration of porosity near the edge has also been observed.

However, using the energy density as a sole measure to control porosity may result in contradictory results. For instance, referring to FIG. 11, the same energy density of E_{ν}=40 J·mm⁻³is obtained for condition P4 (P=180 W and V=1650 mm·s⁻¹) and condition S3 (P=370 W and V=2200 mm·s⁻¹). However, in P4 the DVR=0%, while in the latter DVR˜0.6%. Another anomalous behavior observed in FIG. 11 is that the segment S2 processed at the highest scanning speed (V=3780 mm·s⁻¹) with E_{ν}=23 J·mm⁻³ has a DVR=1.38%. However, this level of porosity is lower for S2 which is processed at V=3000 mm·s⁻¹ (E_{ν}=29 J·mm⁻³) and has a DVR=1.96%.

This outcome in the context of FIG. 11 indicates that the energy density is not a viable universal parameter that can be reliably used to correlate with the porosity severity in LPBF. Similar shortcoming with has been noted. For example, utilizing the same energy density (E_{ν}) obtained by changing different process parameters in LPBF can result in different levels of lack-of-fusion porosity in the part. In general, is not always reliable. Processes may be limited in accuracy that attempt to estimate defects, such as porosity using volumetric energy density.

In general, FIG. 11 shows XCT analysis of various sections showing an effect of laser power (P) and scanning speed (V) on porosity in 3 dimensions. DVR is the defect volume ratio from Volume Graphics software while ρᵣₑₗ is the relative density measured using Archimedes method.

One of the main shortcomings with the volume energy density (E_{ν}) that hampers its generalizability is that it does not include material properties. To overcome this gap, a dimensionless number can be used to aggregate LPBF process parameters and thermophysical properties of the material. This dimensionless number can be related to relative density of a variety of metal alloys. The dimensionless number (Π₁) can be expressed as,

$${Π}_{1} = \frac{{C}_{p} P}{k {V}^{2} h}$$

where Cₚ is specific heat [J kg⁻¹·K⁻¹], P laser power [W], k thermal conductivity [W·K⁻¹·m⁻¹], V laser scanning speed [m·s⁻¹], and h hatch spacing [m].

For a fully dense as-built part, the dimensionless number can be in the range of 61<Π₁<146, which defines an optimal window for selecting process parameters that results in maximum density. Parts built outside this range consistently have a lower density. For Π₁<61, the density is reduced due to lack of fusion porosity while for Π₁>146 it is reduced due to keyhole or gas porosity. There may be a relationship between the relative density of as-built part and the dimensionless number (Π₁) determined by statistical analysis of results. The relative density of a part (ρᵣₑₗ) as a function of Π₁ and be expressed as ρᵣₑₗ=e^{-2.391×10}^{^{−5}}^{Π}^{₁}−0.15e^{-0.06688×Π}^{₁}

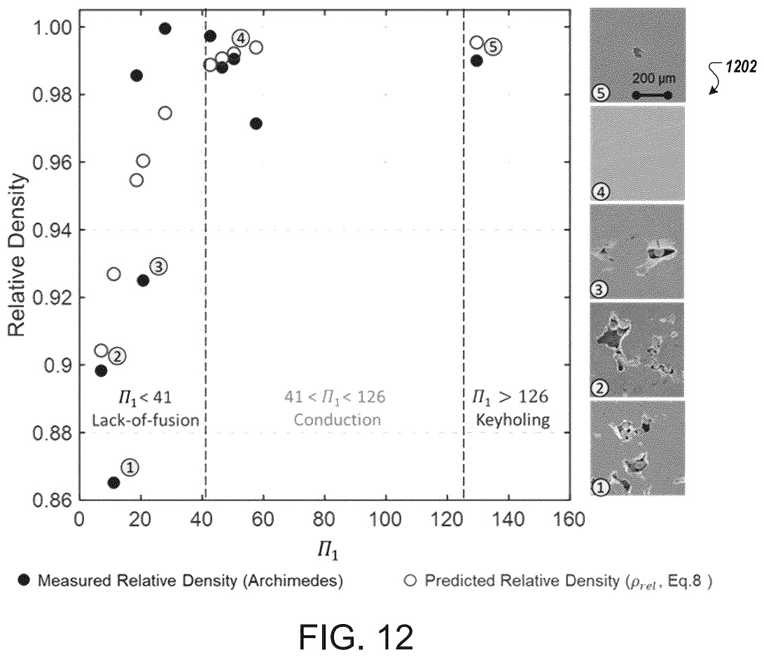

This relationship can be used to verify experimental observations reported in FIG. 10 and Table 4. For this purpose, the Archimedes method can be used to measure the density of test coupons (ρᵣₑₗ). FIG. 12 correlates the dimensionless number (Π₁) with both the measured density from Archimedes method and predicted relative density (ρᵣₑₗ) from the expression of relative density of a part (ρᵣₑₗ). It is observed that the measured density closely follows the predicted density with equivalent labeling of the porosity type.

Based on the dimensionless number (Π₁), as shown in FIG. 12, most of the porosity observed in this work falls in the lack-of-fusion region. The onset of lack-of-fusion porosity was observed for Π₁<41, while keyhole melting was observed for Π₁>126. These match closely with other observations that suggest the onset of lack-of-fusion at Π₁<61 and keyhole at Π₁>146.

The slight discrepancy between the observed relative density values and those predicted by others from the expression of relative density of a part (ρᵣₑₗ) can be attributed to the novelty of the material studied in this work (ATI 718Plus). Moreover, the expression of relative density of a part (ρᵣₑₗ). was derived through statistical regression analysis of porosity observed in eight different LPBF materials ranging from low melting temperature alloys, such as Copper and AlSiMg10 to extreme temperature Nickel-based superalloys and Tungsten. This materials-related distinction also explains differences in the Π₁ regime demarcations.

In general, FIG. 12 shows porosity classification based on relative density as a function of dimensionless number Π₁. SEM images 1202 on the right represent the actual porosity type corresponding to points numbered inside the figure. Lack-of-fusion porosity is observed for Π₁<41, conduction regime (minimal porosity) for 41<Π₁<126, and Keyhole formation for Π₁>126.

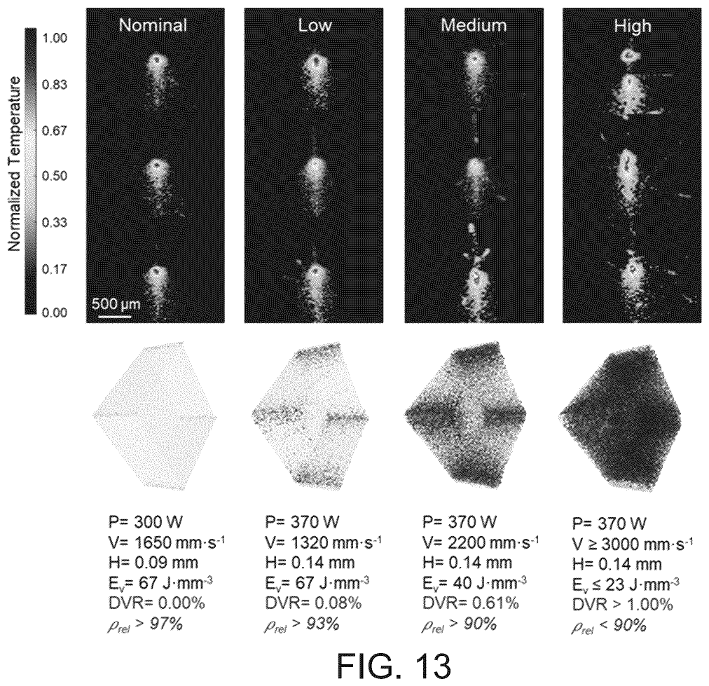

In some implementations, the system 100 includes elements to predict a severity or type of defect using data from an imaging device, such as the imaging device 104. The imaging device 104 can obtain meltpool signatures extracted from a pyrometer of the imaging device 104. For illustration, the XCT for the four levels of porosity levels observed at different processing conditions are depicted in FIG. 13 and visually correlated with meltpool signatures.

In general, FIG. 13 shows correlation of porosity levels with meltpool images acquired from an imaging pyrometer, such as a dual wavelength imaging pyrometer. The shape, size, and temperature of meltpool and ejecta change with porosity level in the part.

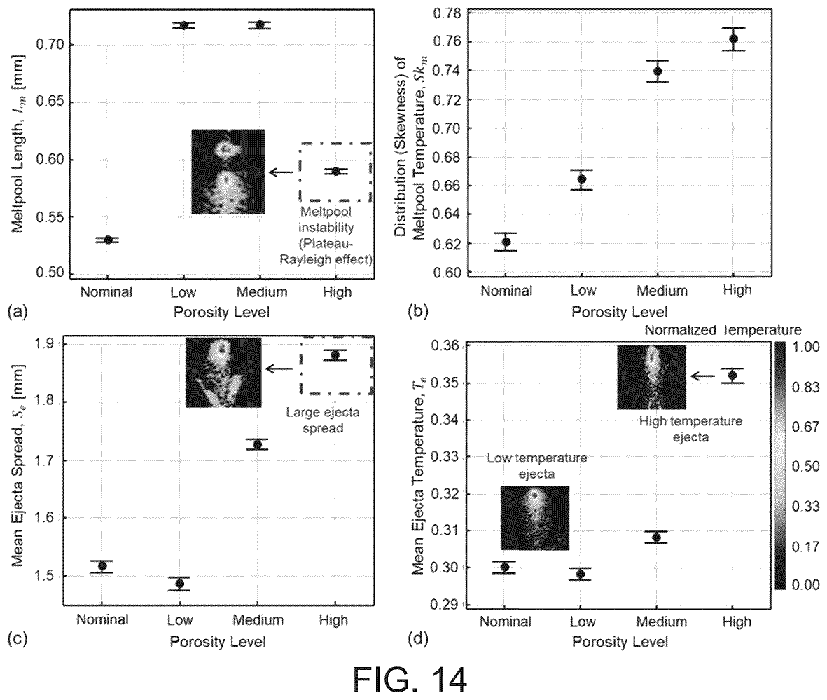

FIG. 14 shows a correlation between different features extracted from a pyrometer, such as a dual-wavelength imaging pyrometer, frames, and the level of porosity. As depicted in FIG. 14, the relationships between the two shape-based features (Meltpool Length (Lₘ) and Mean Ejecta Spread (Sₑ)) and the two temperature-based features (Skewness of Meltpool Temperature (Skₘ) and Mean Ejecta Temperature (Tₑ)), have complex trends.

In general, FIG. 14 shows shape and temperature-based statistical features extracted from pyrometry images, including (a) Meltpool Length (Lₘ), (b) Distribution of Meltpool Temperature (Skₘ), (c) Mean Ejecta Spread (Sₑ), and (d) Mean Ejecta Temperature (Tₑ), as a function of the four porosity levels depicted in FIG. 10.

For example, as shown in panel (a) of FIG. 14, the meltpool length is smaller for the Nominal porosity (DVR=0.00%, ρᵣₑₗ≥99%) condition. The meltpool elongates as the processing condition deviates from the nominal, and ultimately breaks down for processing condition (S2) where High porosity level (DVR>0.61%, ρᵣₑₗ≤90%) was observed. The breakdown of the meltpool at higher scanning speeds was described above as a consequence of the Plateau-Rayleigh effect. The breakdown of the meltpool into separate chunks of molten material leads to poor fusion as depicted in panel (a) of FIG. 9.

The meltpool and ejecta temperature are correlated with porosity levels in panels (b) and (d) of FIG. 14, respectively. It is observed that both the skewness of meltpool temperature (Skₘ) and the mean ejecta temperature (T e) show an increasing trend with porosity level. To explain further, the meltpool temperature distribution (Skₘ) captures the symmetry of the meltpool temperature distribution. High Skₘ indicates increase in skewness and asymmetry. As shown in panel (b) of FIG. 14, Skₘ increases linearly with the porosity level in the part. The increasing positive skewness indicates that a large area of the meltpool has low temperature values. Hence, there is insufficient thermal energy to completely fuse powder particles together, resulting in lack-of-fusion porosity.

The spread of ejecta (Sₑ) as a function of porosity level is mapped in panel (c) of FIG. 14. It is observed that Sₑ increases with the severity of porosity in the part. The ejecta spreads farther as the meltpool becomes instable. The increase in Tₑ in pane (d) of FIG. 14 is also associated with the meltpool instability, which leads to ejection of hot meltpool particles during the process.

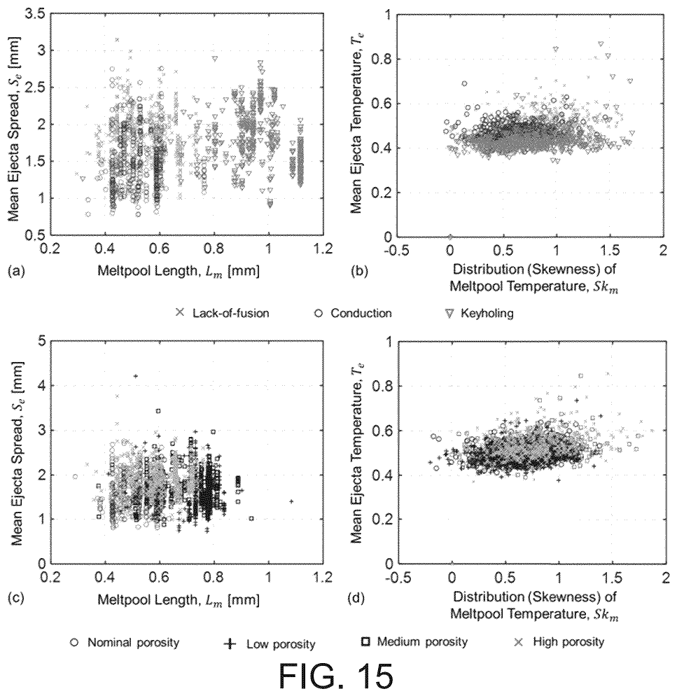

FIG. 15 shows a test of abilities of the four extracted features to differentiate between the three types of porosity and the four porosity levels without the need for a machine learning model. It is noticed that the porosity type (panel (a) and (b) of FIG. 15) shows more discernable clustering compared to pore severity (panel (c) and (d) of FIG. 15). For example, in panel (a) of FIG. 15, while there is significant overlap between lack-of-fusion and conduction (minimal porosity) regimes, a clear separation of features is evident for the keyhole regime. The significant overlap between these clusters and nonlinear interaction between features necessitates the need for machine learning algorithm to predict porosity.

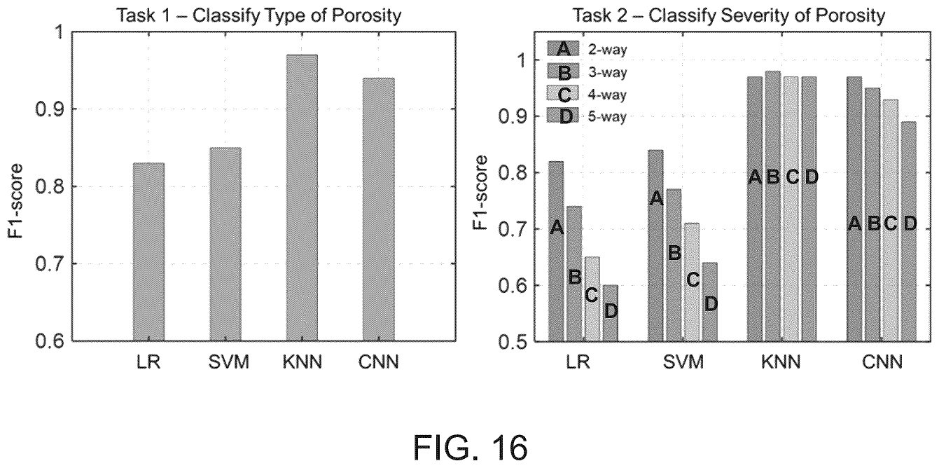

The pore severity and type classification results from the machine learning models, including KNN, SVM, LR, and CNN are shown in Table 5 and pictorially reported in FIG. 16. The results indicate that only four features, as porosity predictors in this study, were sufficient to predict the porosity level in LPBF with accuracy exceeding 95% (F1-score) with a simple KNN model.

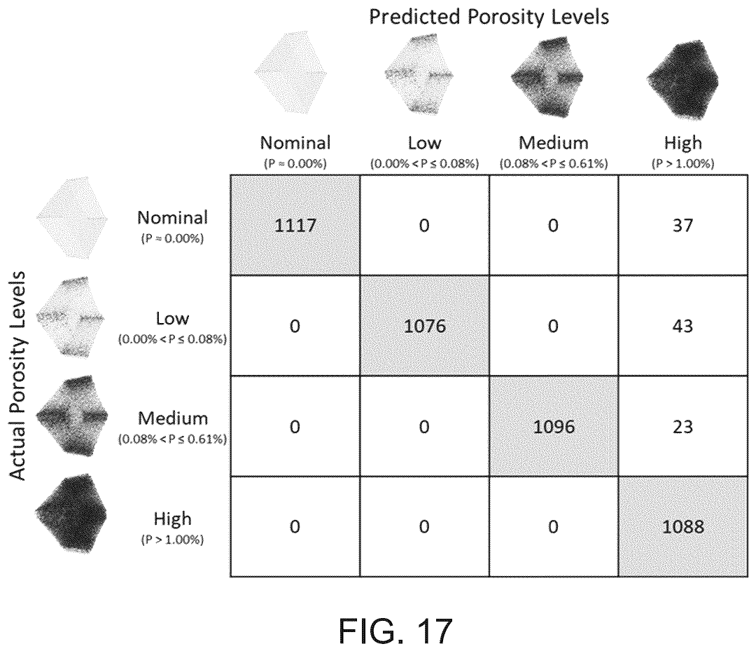

The false positive rate (FPR, Type I error rate) and false negative rate (FNR, Type II error rate) are typically both within 3%. This error mainly originates from mislabeling different porosity levels with the high porosity level. This misclassification can be particularly associated with the breakdown of meltpool for the high scanning speed condition as a result of Plateau-Rayleigh effect, which in turn results in the high porosity level observed in this work. For example, shown in FIG. 17 is the confusion matrix for the 4-way classification of porosity severity using KNN, wherein, the prediction column under high porosity level has values, while all other off-diagonal elements are zero. In other words, the machine learning algorithm can erroneously tag nominal to medium-level porosity as belonging to high porosity.

In general, FIG. 15 shows a correlation between features extracted from dual-wavelength imaging pyrometer frames, where panels (a) and (b) depict type of porosity, and (c) and (d) depict the severity of porosity.

The results reported in table 5 are based on the application of the trained machine learning models to the 20% of the unseen data. The logistic regression (LR) model provides the least prediction fidelity of ˜70%. The large difference in prediction fidelity of LR and KNN (and SVM) stems from the complex (non-linear) relationship between meltpool signatures and porosity. The SVM model has inferior performance compared to the KNN as it uses a linear function (kernel) to demarcate the nonlinear cluster boundaries depicted in FIG. 15. Furthermore, the performance of these physics-informed models was compared with the CNN.

Despite its complex, black-box nature, the CNN did not outperform the KNN model. This is because, CNN models are data hungry and generally require more training data than simpler models. To explain further, CNN models use the meltpool image data directly without explicitly extracting low-level features. Consequently, a considerably larger number of data points is required by the CNN to capture the natural process variation. Thus, increasing the amount of training data could potentially improve the CNN model results (we exhausted the available data in the current work for training the CNN). Therefore, in Table 5, given its inherently data intensive nature, the performance of the CNN degrades compared to KNN with increasing complexity of the classification task. For example, the F1-score for 2-way pore severity classification the CNN achieves an F1-score of 97%, which decreases to 89% for the 5-way case. To ensure that the models were not trained to the verge of overfitting, learning curve analyses were implemented. The results affirm that the number of data points used for training and validating the various models (as reported in Table 1) were appropriate.

TABLE 5
Results of porosity severity and type classification using different machine learning
classifiers in terms of the F1-score, false positive rate (FPR), false negative rate
(FNR). The simple machine learning models like KNN perform at par with a black-box CNN.

| | Logistic | | | Support Vector | | | K-Nearest | | | Convolutional | | |
|---|---|---|---|---|---|---|---|---|---|---|---|---|
| | Regression | | | Machine | | | Neighbors | | | Neural Network | | |
| | (LR) | | | (SVM) | | | (KNN) | | | (CNN) | | |
| Porosity | F1- | | | F1- | | | F1- | | | F1- | | |
| classification | score | FPR | FNR | score | FPR | FNR | score | FPR | FNR | score | FPR | FNR |

Task 1 - Classify Type of Porosity
(Lack-of-fusion, Conduction, Keyholing)

| | | | | | | | | | | | | |
|---|---|---|---|---|---|---|---|---|---|---|---|---|
| 3-way | 0.83 | 0.083 | 0.165 | 0.85 | 0.075 | 0.149 | 0.97 | 0.013 | 0.026 | 0.94 | 0.029 | 0.06 |

Task 2 - Classify Severity of Porosity

| | | | | | | | | | | | | |
|---|---|---|---|---|---|---|---|---|---|---|---|---|
| 2-way | 0.82 | 0.185 | 0.185 | 0.84 | 0.159 | 0.159 | 0.97 | 0.030 | 0.030 | 0.97 | 0.034 | 0.034 |
| 3-way | 0.74 | 0.133 | 0.265 | 0.77 | 0.117 | 0.233 | 0.98 | 0.009 | 0.019 | 0.95 | 0.026 | 0.053 |
| 4-way | 0.65 | 0.114 | 0.341 | 0.71 | 0.097 | 0.029 | 0.97 | 0.009 | 0.027 | 0.93 | 0.024 | 0.072 |
| 5-way | 0.60 | 0.101 | 0.403 | 0.64 | 0.090 | 0.359 | 0.97 | 0.013 | 0.040 | 0.89 | 0.028 | 0.110 |

In general, FIG. 16 shows a graphical representation of a porosity type and severity classification using various machine learning models, viz., Logistic Regression (LR), Support Vector Machine (SVM), K-Nearest Neighbors (KNN), Convolutional Neural Network (CNN) in terms of the F1-score. Note the KNN model with physics-informed features performs at par with the CNN which uses raw meltpool images.

In general, FIG. 17 shows a confusion matrix for 4-way classification of porosity severity using K-nearest neighbor (KNN) model. Misclassification error can originate from mislabeling different porosity levels with the High porosity level.

In general, and as described, systems and methods can enable the online prediction of flaw formation (porosity) in laser powder bed fusion (LPBF) or other additive manufacturing processes, using image data, such as meltpool signatures, acquired from an imaging device (e.g., dual-wavelength pyrometer). The systems and methods can monitor and predict a severity of porosity formation and its type based on one or more (e.g., four) physically intuitive meltpool signatures using simple machine learning models. The correlation of meltpool signatures to porosity is achieved through relatively simple and computationally tractable machine learning models, such as K-Nearest Neighbors (KNN) and Support Vector Machine (SVM).

A simple KNN machine learning model can perform at par (F1-score>95%) to a complex black-box deep learning model. The use of easy and interpretable physics-informed process signatures, coupled with readily implementable machine learning, as opposed to black-box deep learning techniques, facilitates rapid detection of flaws, reduces training time and required training data, and can eliminate the latency in the data transfer and analysis loop inherent to complex data-driven flaw detection algorithms. In some implementations, monitoring and detecting of defects can be used in online, real-time flaw detection, such as qualify-as-you-build processes, in LPBF or other additive manufacturing.

A large LPBF part 10 mm×10 mm×137 mm (ATI 718Plus) can be processed under varying laser power and scanning speed conditions (ten conditions) to engender porosity of different types and varying severity of porosity. A dual wavelength imaging pyrometer can be used to continuously monitor the process. The pyrometer acquires meltpool images and temperature maps at a sampling rate of 800 Hz and resolution of 370×384 pixels (29 μm per pixel spatial resolution).

The type of porosity in the part can be characterized using SEM and optical microscopy. Two types of porosity (lack-of-fusion and keyhole formation) can be observed in the sample. The severity of porosity in the part can be characterized using non-destructive XCT and Archimedes method. The XCT analysis can reveal that the porosity in the samples ranged from 0-2% (defect volume ratio). The corresponding relative density measured from the Archimedes method can be 99%-86%.

Four physically intuitive features can be extracted from meltpool images. These features are based on experimental and theoretical simulation results reported in the literature. For example, two features can capture the shape (morphology) and temperature distribution of the meltpool, and two features can capture the temperature and spatial distribution (spread) of the ejecta (spatter).

These meltpool signatures can be used as inputs to various types of simple machine learning models (e.g., the machine learning model 114), such as Logistic Regression (LR), K-Nearest Neighbors (KNN), Support Vector Machine (SVM) trained to predict the severity and type of porosity. The pore severity and type can be classified with a statistical fidelity (F1-score) exceeding 95% with the KNN.

In general, results obtained from a KNN or other model can be comparable to those from deep learning convolutional neural network (CNN) that uses raw meltpool images instead of meltpool features but with reduced energy usage and reduced processing time. In some implementations, processes discussed can be extended to complex geometries or different materials.

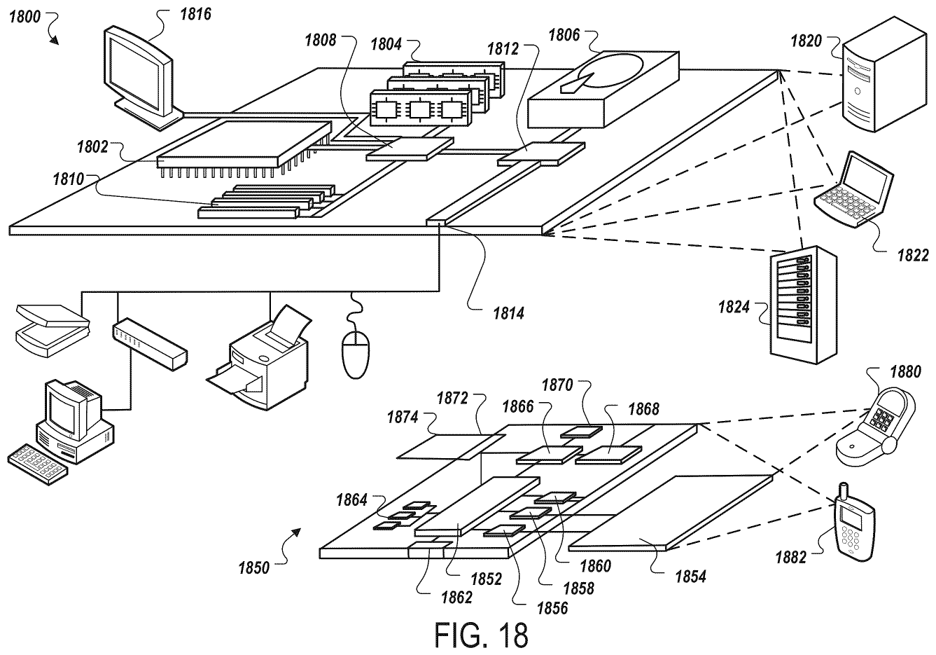

FIG. 18 is a diagram illustrating an example of a computing system used for additive manufacturing defect detection. The computing system includes computing device 1800 and a mobile computing device 1850 that can be used to implement the techniques described herein. For example, one or more components of the system 100 could be an example of the computing device 1800 or the mobile computing device 1850, such as a computer system implementing the control unit 110, devices that access information from the control unit 110, or a server that accesses or stores information regarding the operations performed by the control unit 110.

The computing device 1800 is intended to represent various forms of digital computers, such as laptops, desktops, workstations, personal digital assistants, servers, blade servers, mainframes, and other appropriate computers. The mobile computing device 1850 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 1800 includes a processor 1802, a memory 1804, a storage device 1806, a high-speed interface 1808 connecting to the memory 1804 and multiple high-speed expansion ports 1810, and a low-speed interface 1812 connecting to a low-speed expansion port 1814 and the storage device 1806. Each of the processor 1802, the memory 1804, the storage device 1806, the high-speed interface 1808, the high-speed expansion ports 1810, and the low-speed interface 1812, are interconnected using various busses, and may be mounted on a common motherboard or in other manners as appropriate. The processor 1802 can process instructions for execution within the computing device 1800, including instructions stored in the memory 1804 or on the storage device 1806 to display graphical information for a GUI on an external input/output device, such as a display 1816 coupled to the high-speed interface 1808. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 1802 is a single threaded processor. In some implementations, the processor 1802 is a multi-threaded processor. In some implementations, the processor 1802 is a quantum computer.

The memory 1804 stores information within the computing device 1800. In some implementations, the memory 1804 is a volatile memory unit or units. In some implementations, the memory 1804 is a non-volatile memory unit or units. The memory 1804 may also be another form of computer-readable medium, such as a magnetic or optical disk.

The storage device 1806 is capable of providing mass storage for the computing device 1800. In some implementations, the storage device 1806 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 1802), perform one or more methods, such as those described above. The instructions can also be stored by one or more storage devices such as computer- or machine readable mediums (for example, the memory 1804, the storage device 1806, or memory on the processor 1802).The high-speed interface 1808 manages bandwidth-intensive operations for the computing device 1800, while the low-speed interface 1812 manages lower bandwidth-intensive operations. Such allocation of functions is an example only. In some implementations, the high speed interface 1808 is coupled to the memory 1804, the display 1816 (e.g., through a graphics processor or accelerator), and to the high-speed expansion ports 1810, which may accept various expansion cards (not shown). In the implementation, the low-speed interface 1812 is coupled to the storage device 1806 and the low-speed expansion port 1814. The low-speed expansion port 1814, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1800 may be implemented in a number of different forms, as shown in the figure. For example, it may be implemented as a standard server 1820, or multiple times in a group of such servers. In addition, it may be implemented in a personal computer such as a laptop computer 1822. It may also be implemented as part of a rack server system 1824. Alternatively, components from the computing device 1800 may be combined with other components in a mobile device, such as a mobile computing device 1850. Each of such devices may include one or more of the computing device 1800 and the mobile computing device 1850, and an entire system may be made up of multiple computing devices communicating with each other.

The mobile computing device 1850 includes a processor 1852, a memory 1864, an input/output device such as a display 1854, a communication interface 1866, and a transceiver 1868, among other components. The mobile computing device 1850 may also be provided with a storage device, such as a micro-drive or other device, to provide additional storage. Each of the processor 1852, the memory 1864, the display 1854, the communication interface 1866, and the transceiver 1868, are interconnected using various buses, and several of the components may be mounted on a common motherboard or in other manners as appropriate.

The processor 1852 can execute instructions within the mobile computing device 1850, including instructions stored in the memory 1864. The processor 1852 may be implemented as a chipset of chips that include separate and multiple analog and digital processors. The processor 1852 may provide, for example, for coordination of the other components of the mobile computing device 1850, such as control of user interfaces, applications run by the mobile computing device 1850, and wireless communication by the mobile computing device 1850.

The processor 1852 may communicate with a user through a control interface 1858 and a display interface 1856 coupled to the display 1854. The display 1854 may be, for example, a TFT (Thin-Film-Transistor Liquid Crystal Display) display or an OLED (Organic Light Emitting Diode) display, or other appropriate display technology. The display interface 1856 may include appropriate circuitry for driving the display 1854 to present graphical and other information to a user. The control interface 1858 may receive commands from a user and convert them for submission to the processor 1852. In addition, an external interface 1862 may provide communication with the processor 1852, so as to enable near area communication of the mobile computing device 1850 with other devices. The external interface 1862 may provide, for example, for wired communication in some implementations, or for wireless communication in other implementations, and multiple interfaces may also be used.

The memory 1864 stores information within the mobile computing device 1850. The memory 1864 can be implemented as one or more of a computer-readable medium or media, a volatile memory unit or units, or a non-volatile memory unit or units. An expansion memory 1874 may also be provided and connected to the mobile computing device 1850 through an expansion interface 1872, which may include, for example, a SIMM (Single In Line Memory Module) card interface. The expansion memory 1874 may provide extra storage space for the mobile computing device 1850, or may also store applications or other information for the mobile computing device 1850. Specifically, the expansion memory 1874 may include instructions to carry out or supplement the processes described above, and may include secure information also. Thus, for example, the expansion memory 1874 may be provide as a security module for the mobile computing device 1850, and may be programmed with instructions that permit secure use of the mobile computing device 1850. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 1852), perform one or more methods, such as those described above. The instructions can also be stored by one or more storage devices, such as one or more computer- or machine-readable mediums (for example, the memory 1864, the expansion memory 1874, or memory on the processor 1852). In some implementations, the instructions can be received in a propagated signal, for example, over the transceiver 1868 or the external interface 1862.

The mobile computing device 1850 may communicate wirelessly through the communication interface 1866, which may include digital signal processing circuitry in some cases. The communication interface 1866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 1868 using a radio frequency. In addition, short-range communication may occur, such as using a Bluetooth, Wi-Fi, or other such transceiver (not shown). In addition, a GPS (Global Positioning System) receiver module 1870 may provide additional navigation- and location-related wireless data to the mobile computing device 1850, which may be used as appropriate by applications running on the mobile computing device 1850.

The mobile computing device 1850 may also communicate audibly using an audio codec 1860, which may receive spoken information from a user and convert it to usable digital information. The audio codec 1860 may likewise generate audible sound for a user, such as through a speaker, e.g., in a handset of the mobile computing device 1850. Such sound may include sound from voice telephone calls, may include recorded sound (e.g., voice messages, music files, among others) and may also include sound generated by applications operating on the mobile computing device 1850.

The mobile computing device 1850 may be implemented in a number of different forms, as shown in the figure. For example, it may be implemented as a cellular telephone 1880. It may also be implemented as part of a smart-phone 1882, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
obtaining an image representing a volume of molten material;
extracting one or more features from the image;
providing the one or more features to a trained machine learning model;
obtaining output from the trained machine learning model; and
determining, using the output, a defect in a part.

2. The method of claim 1, wherein determining the defect comprises:
determining a severity of porosity.

3. The method of claim 1, wherein determining the defect comprises:
determining a type of defect.

4. The method of claim 3, wherein the type of defect is lack of fusion, conduction, or keyholing.

5. The method of claim 1, comprising:
providing feedback to an additive manufacturing process, wherein the feedback is configured to adjust a manufacturing of the part.

6. The method of claim 5, wherein adjusting the manufacturing of the part comprises adjusting one or more of a laser power, scanning speed, or delay.

7. The method of claim 1, wherein determining the defect in the part comprises determining that continuing an additive manufacturing process will cause the defect in the part without adjustments to the additive manufacturing process.

8. The method of claim 1, wherein the one or more features include one or more of a value indicating a length of the volume, a value indicating a spread of ejecta, a value indicating a temperature of ejecta, or a value indicating a temperature of the volume.

9. The method of claim 1, wherein the one or more features include one or more values indicating a shape of the volume of molten material.

10. The method of claim 1, wherein the trained machine learning model includes one or more of a Logistic Regression (LR) model, a Support Vector Machine (SVM), or K-Nearest Neighbors (KNN) algorithm.

11. The method of claim 1, comprising:
providing an indication that a second part has no defect.

12. A non-transitory computer-readable medium storing one or more instructions executable by a computer system to perform operations comprising:
obtaining an image representing a volume of molten material;
extracting one or more features from the image;
providing the one or more features to a trained machine learning model;
obtaining output from the trained machine learning model; and
determining, using the output, a defect in a part.

13. The medium of claim 12, wherein determining the defect comprises:
determining a severity of porosity.

14. The medium of claim 12, wherein determining the defect comprises:
determining a type of defect.

15. The medium of claim 14, wherein the type of defect is lack of fusion, conduction, or keyholing.

16. The medium of claim 12, wherein the operations comprise:
providing feedback to an additive manufacturing process, wherein the feedback is configured to adjust a manufacturing of the part.

17. The medium of claim 16, wherein adjusting the manufacturing of the part comprises adjusting one or more of a laser power, scanning speed, or delay.

18. The medium of claim 12, wherein determining the defect in the part comprises determining that continuing an additive manufacturing process will cause the defect in the part without adjustments to the additive manufacturing process.

19. The medium of claim 12, wherein the one or more features include one or more of a value indicating a length of the volume, a value indicating a spread of ejecta, a value indicating a temperature of ejecta, or a value indicating a temperature of the volume.

20. A system, comprising:
one or more processors; and
machine-readable media interoperably coupled with the one or more processors and storing one or more instructions that, when executed by the one or more processors, perform operations comprising:
obtaining an image representing a volume of molten material;
extracting one or more features from the image;
providing the one or more features to a trained machine learning model;
obtaining output from the trained machine learning model; and
determining, using the output, a defect in a part.
